(19) United States
(12) Patent Application Publication
(10) Pub. No.: US 2011/0141126 A1
(43) Pub. Date: Jun. 16, 2011

(54) System And Method For Rendering Advertisements On An Electronic Device

(75) Inventor: Serge Rutman, Boulder Creek, CA (US)

(73) Assignee: SKIFF, INC., NEW YORK, NY (US)

(21) Appl. No.: 12/639,512

(22) Filed: Dec. 16, 2009

(51) Int. Cl. G09G 5/00

(52) U.S. Cl. 345/581; 345/76

(57) ABSTRACT

An electronic device for rendering advertisements includes a processor; a network interface; a low-power display; and an executable computer program that is tangibly embodied on a computer readable medium. The computer code may: receive an indication that the electronic device is going to be put in a reduced power state; render a first advertisement on the low-power display before entering the reduced power state; and enter the reduced power state. The first advertisement may remain visible on the low-power display after the device enters the reduced power state. The low-power display may be an electrophoretic display. A method for rendering advertisements on an electronic device having a low-power display may include receiving an indication that the electronic device is going to be put in a reduced power state; rendering a first advertisement on the low-power display; and entering the reduced power state. The low-power display may be an electrophoretic display.

### BACKGROUND INFORMATION

Advertising is a part of everyday life. Many advertisements are designed to inform consumers of products and services and to generate (or maintain) a brand image. There are many media used to deliver these messages, including traditional media such as television, radio, magazines, newspapers, video games, shopping bags, billboards, mail, and Internet marketing. Advertisements are a major source of revenue, and can be used to reduce consumer costs for goods and/or services.

### BRIEF DESCRIPTION OF THE DRAWINGS

The present invention, together with further objects and advantages, may best be understood by reference to the following description taken in conjunction with the accompanying drawings, in several figures of which like reference numerals identify like elements, and in which:

FIG. 1 is a block diagram of an electronic device for rendering advertisements according to one embodiment of the present invention;

FIG. 2 is a block diagram of a system for rendering advertisements according to one embodiment;

FIG. 3 is a flowchart depicting a method for rendering advertisements according to one embodiment; and

FIG. 4 is a flowchart depicting a method for rendering cyclic advertisements according to one embodiment.

### DETAILED DESCRIPTION OF PREFERRED EMBODIMENTS

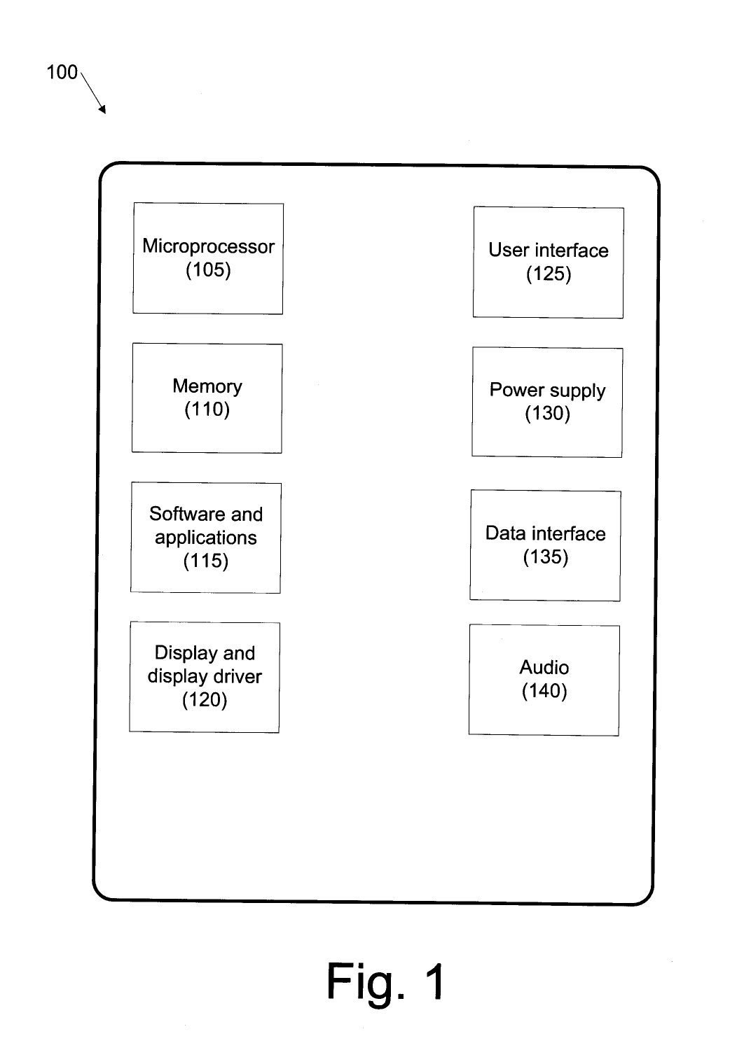

Several embodiments of the present invention and their advantages may be understood by referring to FIGS. 1-4 wherein like reference numerals refer to like elements.

As used herein, the term “advertisement” not only includes traditional advertisements (e.g., advertisements for goods and/or services), but also includes content for which the continued display is valuable to a user when an electronic devices is in a low-power, or “off” state. This content may be referred to as “personal content.” For example, a user may find value in having a map to his or her next appointment displayed on the electronic device even though the device is “off.” As another example, the user find value in having a picture of the family dog displayed whenever the device is “off.” As yet another example, a user may find value in having his or her travel itinerary displayed on the device even when it is “off.”

Referring to FIG. 1, a block diagram of an electronic device is provided. In general, electronic device 100 may include processor 105, memory 110, software and applications 115, display and display driver 120, user interface 125, power supply 130, data interface 135, and audio 140. Other features may be provided as necessary and/or desired.

Processor 105 provides some, or all, of the processing power for electronic device 100. Processor 105 may be any suitable processor or integrated circuit, including microprocessors, programmed microprocessors micro-controllers, peripheral integrated circuit elements, CSICs (Customer Specific Integrated Circuit) or ASICs (Application Specific Integrated Circuit), logic circuits, digital signal processors, programmable logic devices such as FPGAs, PLDs, PLAs or PALs, or any other device or arrangement of devices that is capable of performing the function of a microprocessor.

Memory 110 may be any suitable memory, and may be used to store software and applications 115. Memory 110 may be volatile or non-volatile as necessary and/or desired. Memory 110 may include static RAM, dynamic RAM, flash memory, magnetic memory, optical memory, etc.

In one embodiment, memory 110 may store data files, including electronic content files, style sheets, advertisements, user preferences, etc. In one embodiment, software and applications 115 render an image on the display of electronic device 100.

Display and drivers 120 are provided for displaying characters, graphics, videos, pictures, etc. for the user. The display may be a suitable low-power display, including flexible displays, touch-sensitive displays, etc.

In one embodiment, the display may be an electrophoretic display. Electrophoretic displays generally have low power requirements and are thin. Once an image is rendered on an electrophoretic display, little or no power is typically required to maintain the image.

Electrophoretic displays include electronic paper displays. An example electronic paper displays is electronic ink, or “e-Ink,” developed by E-Ink Corporation, Cambridge, Mass. Examples of devices using E-Ink include the Sony Reader, the Lexar JumpDrive® Mercury, the iRex iLiad, the Broadsheet™ AM300 EPD Prototype Kits, and the Motorola FONE F3.

Another example of an electronic paper display is the SiPix MicroCup® electronic paper, available from SiPix Imaging, Inc., Freemont, Calif. Displays that include this technology are available from AU Optronics Corporation, Taiwan.

The display may also be a non-electrophoretic display, including, for example, conventional liquid crystal displays (LCD). In one embodiment, these displays may be coupled with electronics that allow the display to be operated in a standard power state, and a reduced power state. In another embodiment, transflective LCDs may be used. An example of a transflective LCD provider is Pixel Qi, San Bruno, Calif. In one embodiment, these transflective LCDs may operate with a reduced frequency scan and with a reduced or turned-off backlight.

Other displays may be used as necessary and/or desired.

In another embodiment, electronic device 100 may be provided with multiple displays. This may be particularly applicable for electronic devices that fold or close, such as a laptop computer, a clamshell cellular telephone, etc. For example, a primary display, which may be any sort of display, may be provided on the “inside” of electronic device 100, while a secondary display, which may be a low-power display, such as an electrophoretic display, may be provided on the outside of the “cover” of the electronic device. In one embodiment, the primary display may be a LCD display, and the secondary display may be a rugged electrophoretic display (e.g., Prime View International's EPLaR (electronics on plastic by laser release) display, LG Display's metal foil display). In this embodiment, since the LCD display is more fragile than the rugged electrophoretic display, advertisements may still be displayed even when the primary display is in the protected (closed) state.

In another embodiment, the secondary display may display advertisements or information even when the primary display of the electronic device is in use. For example, if the secondary display is provided on the outside cover of a laptop computer, advertisements and information may nonetheless be displayed on the secondary display as they will be viewed by those observing the user.

User interface 125 may be provided for the user to interact with electronic device 100. Any suitable input mechanism may be provided, including buttons, trackballs, joysticks, etc. In another embodiment, a touch-sensitive screen may be provided. In still another embodiment, a microphone may be provided to detect speech. In another embodiment, a digital camera may be provided. Other inputs may be provided as necessary and/or desired, depending on particular functionality that the electronic device provides.

Electronic device 100 may be powered by power supply 130, such as a battery, AC power, DC power through an AC adapter, etc.

Electronic device 100 may also be provided with data interface 135. In one embodiment, data interface may communicate by any suitable wired or wireless communication method, including cellular communications, a USB interface, unshielded twisted pair interface, radio frequency (RF), infrared (IR), Bluetooth, near field communication, WiFi (e.g., any suitable IEEE 802.11 protocol), etc.

In one embodiment, electronic device 100 may be provided with audio capability 140. This may include integrated speakers, a headphone jack, etc.

In one embodiment, electronic device 100 may be provided with a location sensing device, such as a GPS device (not shown).

Any electronic device having a display that can render electronic content or images may be used. In one embodiment, electronic device 100 may be an electronic reading device. Examples of electronic reading devices include electronic book readers, electronic newspaper readers, electronic paper readers, etc. Examples of an electronic display device are disclosed in U.S. patent application Ser. No. 12/481,677, entitled “Flexible Electronic Device And Method Of Manufacture”; U.S. patent application Ser. No. 12/248,331, entitled “Foldable Media Device,” U.S. patent application Ser. No. 12/332,860, entitled “Touch Sensitive Illuminated Display”; U.S. patent application Ser. No. 12/549,785, entitled “Thin Reader Device”; and U.S. patent application Ser. No. 12/574,721 entitled “Always On Reader Device.” The disclosures of each of these patent applications is incorporated, by reference, in its entirety.

Other examples of electronic reading devices include the Amazon Kindle, the Sony Reader, the Plastic Logic Reader, and the iRex iLiad electronic reader.

Other examples of electronic devices include computers (desktops, notebooks, laptops, tablets, webbooks, netbooks, etc.), personal digital assistants (PDAs), digital cameras, digital picture frames, music players, portable video players, video game players, telephones, mobile telephones, etc.

Other related disclosures include U.S. patent application Ser. No. 60/978,748, entitled “Content Distribution And Preloading”; U.S. patent application Ser. No. 12/481,336, entitled “System And Method For Providing Spatial And Temporal Content In An Electronic Device”; U.S. patent application Ser. No. 12/481,705, entitled “System And Method For Providing Sub-Publication Content In An Electronic Device”; U.S. patent application Ser. No. 12/481,306, entitled “Electronic Paper Display Device Event Tracking”; U.S. patent application Ser. No. 12/481,365, entitled “System And Method For Delivering Publication Content To Reader Devices Using Mixed Mode Transmission”; U.S. patent application Ser. No. 12/575,009 entitled “Electronic Advertisement Placement”; and U.S. patent application Ser. No. 12/481,365 entitled “System And Method For Delivering Publication Content To Reader Devices Using Mixed Mode Transmission.” The disclosures of each of these patent applications is incorporated, by reference, in its entirety.

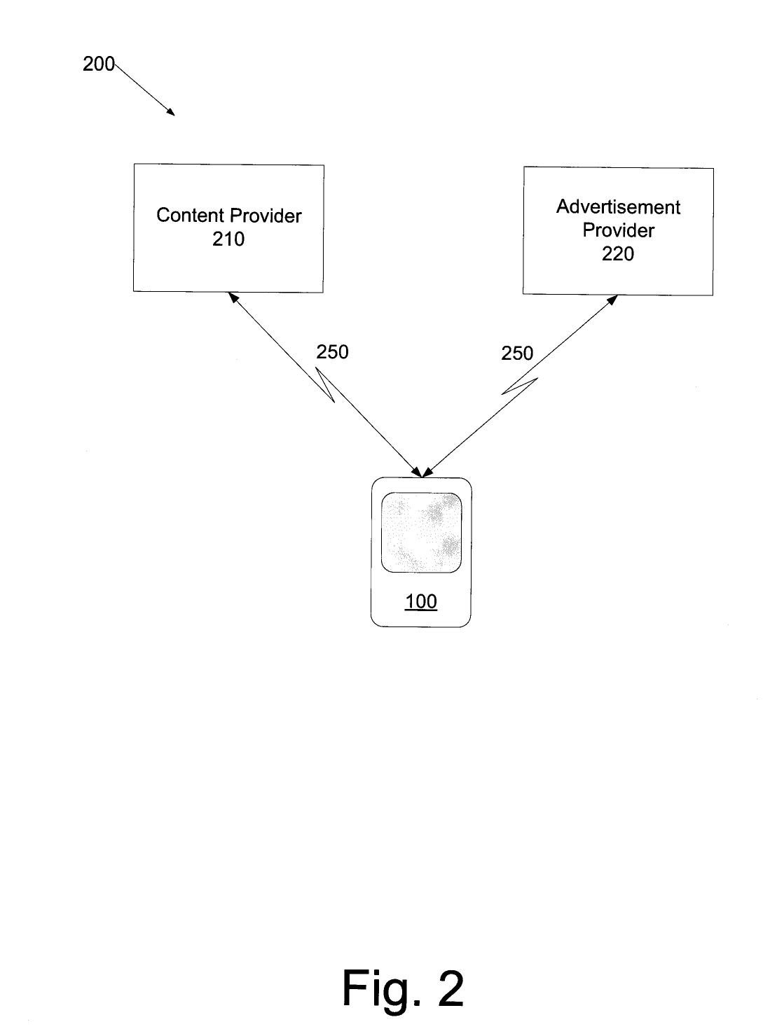

Referring to FIG. 2, a system for rendering advertisements on an electronic device is provided. System 200 includes electronic device 100, content provider 210 and advertisement provider 220.

In one embodiment, content provider 210 and advertisement provider 220 may be the same entity.

In one embodiment, content provider 210 may provide content that is rendered on an electronic reading device. Examples of content provider 210 include newspaper publishers, periodical publishers, book publishers, Internet authors, schools, government agencies, etc.

In one embodiment, content provider 210 may be the author of the content. In another embodiment, content provider 210 may be a distributor of content.

In one embodiment, advertisement provider 220 may be, for example, a business entity that provides advertisements to electronic device 100. Advertisement provider 220 may also be an individual. In another embodiment, advertisement provider 220 may be an aggregator or advertisements.

Electronic device 100 may communicate with content provider and/or advertisement provider 220 by communication link 250. Communication link 250 may be any suitable wired or wireless communication method, including cellular communications, a USB interface, unshielded twisted pair interface, radio frequency (RF), infrared (IR), Bluetooth, near field communication, WiFi (e.g., any suitable IEEE 802.11 protocol), etc.

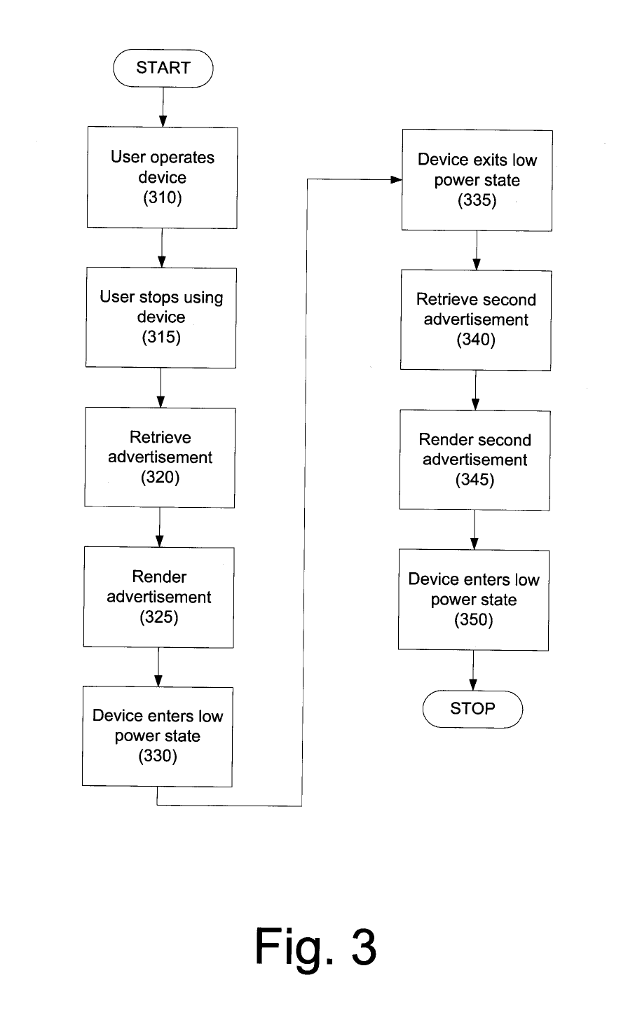

Referring to FIG. 3, a method for rendering advertisements is provided. In step 310, a user operates an electronic device. For example, the user may use an electronic reading device to display electronic content (e.g., an electronic newspaper, an electronic book, etc.).

In step 315, the user may start to power off the electronic device, or put the electronic device in a low-power (e.g., sleep or hibernation) state. This may be achieved by any suitable mechanism for the electronic device. For example, the user may press the power button, slide an on/off slider, touch an area of a touch-sensitive screen, give a voice command, click on an icon on the display, etc.

In one embodiment, the device may power itself off after a period of inactivity.

In step 320, the device may retrieve at least one advertisement to render on the display when the device is powered off or in a low-power state. In one embodiment, the device may retrieve the advertisement from device memory. In another embodiment, the device may retrieve the advertisement from a network location.

Advertisements may be provided to the electronic device in any suitable manner. In another embodiment, advertisements may be “pushed” to the electronic device from, for example, an advertisement source. In another embodiment, advertisements may be provided as part the content that is to be rendered. In another embodiment, the electronic device may retrieve advertisements from a network location, periodically or as required.

In one embodiment, advertisements may be provided based on the location of the electronic device. For example, if the electronic device is near a shopping center, the electronic device may receive advertisements from stores in that shopping center.

Other sources of advertisements may be used as necessary and/or desired.

As noted above, advertisements may include personal content. In one embodiment, the user may elect to opt-out of receiving and having displayed traditional advertisements in order to have his or her personal content displayed. In one embodiment, the user may be charged a fee to opt-out of receiving (and having displayed) traditional advertisements.

In one embodiment, the user may submit his or her personal content to the advertisement provider in order for it to be provided to the electronic device. In another embodiment, the user may identify a source of the personal content that is to be displayed by the electronic device. Other ways of identifying or providing personal content to be displayed may be used as necessary and/or desired.

In step 325, the advertisement is rendered on the display. In one embodiment, an electrophoretic display that requires little or no power to maintain the rendered display may be used.

In step 330, after rendering the advertisement on the display, the electronic device may enter a low or no power state. In one embodiment, because the display requires little or no power to maintain the display, the advertisement remains on the display in this low-power (or no power) state. In this manner, the advertisement can be considered to be “persistent” in that it remains on the display even after the device is put into a low, or no, powers state.

In one embodiment, the electronic device may use only the power necessary to maintain any essential features (e.g., memory, clock, etc.). In one embodiment, if necessary, the electronic device may also use power to maintain the display.

The advertisements may be changed periodically. In one embodiment, the period for advertisements may be determined by the advertisement provider. In another embodiment, the user may desire to change the advertisement. Other periods and/or reasons for changing the advertisement may be provided as necessary and/or desired.

In step 335, the electronic device may exit the low, or no, power state. In one embodiment, this may be in response to the passage of a predetermined period of time, the passage of a random amount of time, a user request, etc.

In one embodiment, the advertisement may be changed in view of an event. For example, the advertisement may change if the electronic device is transported to a different area, near a facility (e.g., near a shopping center, a movie theater, airport, etc.), a tourist attraction (e.g., an amusement park), etc.

In step 340, the electronic device may retrieve a second advertisement. The second advertisement may be retrieved using the same methods and sources as described with regard to step 320.

In step 345, the second advertisement is rendered on the display. This is similar to step 325.

In step 350, the device enters a low-power or no power state. This is similar to step 330.

In one embodiment, the process may repeat in order to cycle through different advertisements. In another embodiment, only the first advertisement may be displayed.

In one embodiment, an advertisement may remain rendered on the display until the electronic device is turned on by the user. In another embodiment, an advertisement may remain rendered on the display unless a predetermined condition is met. For example, the display may be cleared at a certain time of day, which may be set by the user. In another embodiment, the display may be cleared if the device is not used for a certain period of time.

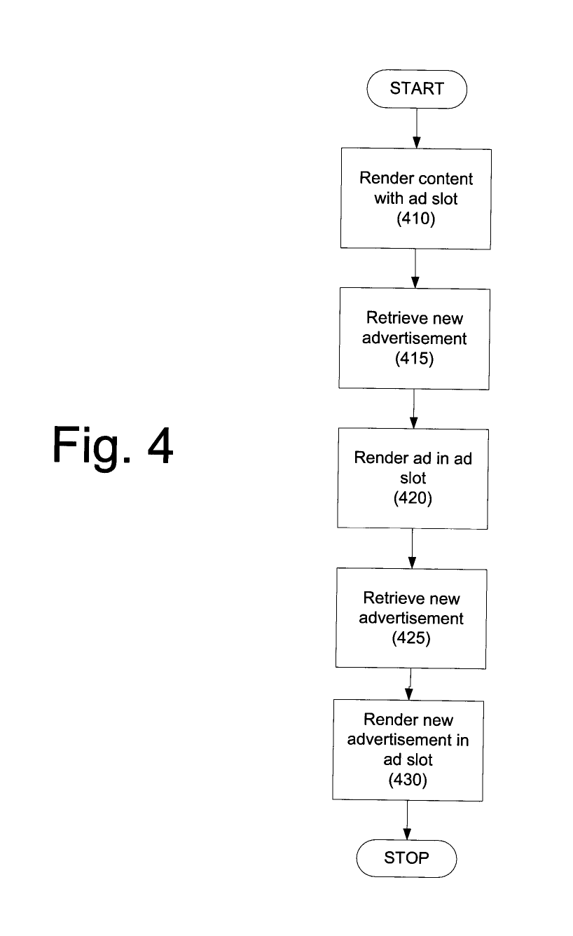

Referring to FIG. 4. a method for cycling advertisements is provided. In step 410, content having a slot for at least one advertisement is rendered.

In step 415, at least one advertisement is retrieved for the advertisement slot. In one embodiment, the device may retrieve the advertisement from device memory. In another embodiment, the device may retrieve the advertisement from a network location.

Advertisements may be provided to the electronic device in any suitable manner. In another embodiment, advertisements may be “pushed” to the electronic device from, for example, an advertisement source. In another embodiment, advertisements may be provided as part the content that is to be rendered. In another embodiment, the electronic device may retrieve advertisements from a network location, periodically or as required.

In step 420, the retrieved advertisement may be rendered in the advertisement slot.

In step 425, at least one new advertisement is retrieved for the advertisement slot. In one embodiment, a new advertisement may be retrieved after a predetermined period of time has passed. For example, a new ad may be retrieved every minute.

In step 430, the new advertisement is displayed in the advertisement slot.

The process may be repeated as necessary and/or desired.

The advertisements described herein may be general advertisements, or they may be targeted to the user. For example, in one embodiment, the user may enter data that may be used to target advertisements to the user. For example, the user may enter information concerning his or her age, geographical location, hobbies and interests, etc. In one embodiment, this information may be stored in the device memory of the electronic device.

In another embodiment, a location sensing device (e.g., GPS, cellular triangulation, etc.) in the electronic device may be used to provide a geographical location of the electronic device.

In one embodiment, software and applications in the electronic device may use the data to select appropriate advertisements to render for the user.

In another embodiment, this data may be sent to the advertisement provider in order to select appropriate advertisements to send to the electronic device. In one embodiment, the data that is sent may be selected in order to maintain the anonymity of the user.

In one embodiment, the advertisements rendered may include a hyperlink that may be activated or selected so they can learn more about the subject matter of the advertisement. For example, in one embodiment, a hyperlink may be provided that allows the user to purchase the subject matter of the advertisement. As another example, a hyperlink may be provided to a book review regarding a book that is advertised. As yet another example, a link to a ticket broker may be provided in an advertisement for a sporting event.

A method for rendering advertisements on an electronic device having a low-power display is disclosed. According to one embodiment, the method includes (1) receiving an indication that the electronic device is going to be put in a reduced power state; (2) rendering a first advertisement on the low-power display; and (3) entering the reduced power state. In one embodiment, the first advertisement may remain visible on the low-power display after the device enters the reduced power state. In another embodiment, the first advertisement may remain visible on the low-power display for a predetermined period of time after the device enters the reduced power state.

The method may further include (4) exiting the reduced power state; (5) rendering a second advertisement on the low-power display; and (6) entering the reduced power state.

The low-power display may be an electrophoretic display, and the electrophoretic display may be an electronic paper display.

In one embodiment, the advertisements may be targeted to a user.

In one embodiment, the electronic device may be an electronic reading device, and the advertisements may be provided with electronic reading content to be rendered.

A method for rendering cyclic advertisements on an electronic device is disclosed. According to one embodiment, the method includes (1) receiving electronic content to render on a display of the electronic device, the electronic content having at least one advertisement slot; (2) rendering the content on the electronic device; (3) retrieving a first advertisement to render in the advertisement slot; (4) rendering the first advertisement on the display in the advertisement slot; (5) retrieving a second advertisement to render in the advertisement slot; and (6) rendering the second advertisement on the display in the advertisement slot.

The step of retrieving a second advertisement to render in the advertisement slot may occur after the occurrence of a predetermined event, and the predetermined event may be the passage of a predetermined period of time.

In one embodiment, the advertisements may be targeted to a user.

An electronic device for rendering advertisements is disclosed. According to one embodiment, the electronic device includes a processor; a network interface; a low-power display; and an executable computer program that is tangibly embodied on a computer readable medium. The computer code may perform the following: receive an indication that the electronic device is going to be put in a reduced power state; render a first advertisement on the low-power display before entering the reduced power state; and enter the reduced power state. The first advertisement may remain visible on the low-power display after the device enters the reduced power state.

The first advertisement may remain visible on the low-power display for a predetermined period of time after the device enters the reduced power state.

The executable computer program may further perform the following: exit the reduced power state; render a second advertisement on the low-power display; and enter the reduced power state.

The low-power display may be an electrophoretic display, and the electrophoretic display may be an electronic paper display.

In one embodiment, the electronic device is an electronic reading device.

The electronic device may receive the first advertisement through the network interface.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, light pen, keyboard, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A method for rendering advertisements on an electronic device having a low-power display, comprising:
receiving an indication that the electronic device is going to be put in a reduced power state;
rendering a first advertisement on the low-power; and
entering the reduced power state;
wherein the first advertisement remains visible on the low-power after the device enters the reduced power state.

2. The method of claim 1, wherein the low-power display is an electrophoretic display.

3. The method of claim 1, wherein the first advertisement remains visible on the low-power display for a predetermined period of time after the device enters the reduced power state.

4. The method of claim 1, further comprising:
exiting the reduced power state;
rendering a second advertisement on the low-power display; and
entering the reduced power state.

5. The method of claim 2, wherein the electrophoretic display is electronic paper.

6. The method of claim 1, wherein the step of receiving an indication that the electronic device is going to be put in a reduced power state comprises:
receiving a user input to put the electronic device in a reduced power state.

7. The method of claim 4, wherein the step of exiting the reduced power state is performed after the occurrence of a predetermined event.

8. The method of claim 1, wherein the first advertisement is targeted to a user.

9. The method of claim 1, wherein the first advertisement is pushed to the electronic device from an advertisement provider.

10. The method of claim 1, wherein the electronic device is an electronic reading device, and the first advertisement is provided with electronic reading content to be rendered.

11. A method for rendering cyclic advertisements on an electronic device, comprising:
receiving electronic content to render on a display of the electronic device, the electronic content having at least one advertisement slot;
rendering the content on the electronic device;
retrieving a first advertisement to render in the advertisement slot;
rendering the first advertisement on the display in the advertisement slot;
retrieving a second advertisement to render in the advertisement slot; and
rendering the second advertisement on the display in the advertisement slot.

12. The method of claim 11, wherein the step of retrieving a second advertisement to render in the advertisement slot occurs after the occurrence of a predetermined event.

13. The method of claim 12, wherein the predetermined event is the passage of a predetermined period of time.

14. The method of claim 11, wherein at least one of the first advertisement and the second advertisement is targeted to a user.

15. An electronic device for rendering advertisements, comprising:
an electronic device, the electronic device comprising:
a processor;
a network interface;
a low-power display; and
an executable computer program that is tangibly embodied on a computer readable medium, which performs the following:
receive an indication that the electronic device is going to be put in a reduced power state;
render a first advertisement on the low-power display before entering the reduced power state; and
enter the reduced power state;
wherein the first advertisement remains visible on the low-power display after the device enters the reduced power state.

16. The electronic device of claim 15, wherein the executable computer program further performs the following:
exit the reduced power state;
render a second advertisement on the low-power display; and
enter the reduced power state.

17. The electronic device of claim 15, wherein the low-power display is an electrophoretic display.

18. The electronic device of claim 17, wherein the electrophoretic display is an electronic paper display.

19. The electronic device of claim 15, wherein the electronic device is an electronic reading device.

20. The electronic device of claim 15, further comprising:
a second display, wherein the second display is used when the electronic device is in an “on” state.
